(19) United States
(12) Patent Application Publication
(10) Pub. No.: US 2025/0287158 A1
(43) Pub. Date: Sep. 11, 2025

(54) METHOD FOR OPERATING A HEARING AID SYSTEM, HEARING AID SYSTEM AND METHOD FOR PUTTING A HEARING AID SYSTEM INTO OPERATION

(71) Applicant: Sivantos Pte. Ltd., Singapore (SG)

(72) Inventors: Cecil WILSON, Erlangen (DE); Jurek FÖLLMER, Erlangen (DE); Christoph LÜKEN, Erlangen (DE)

(21) Appl. No.: 19/073,358

(22) Filed: Mar. 7, 2025

(30) Foreign Application Priority Data
Mar. 7, 2024 (DE) 10 2024 202 131.8

(51) Int. Cl. H04R 25/00

(52) U.S. Cl. CPC H04R 25/43; H04R 25/505; H04R 2225/43; H04R 2430/01

(57) ABSTRACT

A method for operating a hearing aid system includes creating an input signal based on ambient sound. The input signal is divided into a first signal component and a second signal component. The first signal component corresponds to speech of a user and the second signal component does not correspond to speech of the user. A first processed signal is created based on the first signal component and a first amplification factor, and a second processed signal is created based on the second signal component and a second amplification factor. The two processed signals are combined to form an output signal. The first amplification factor is selected depending on a ratio of the first signal component to the second signal component. A hearing aid system and a method for putting a hearing aid system into operation are also provided.

### CROSS-REFERENCE TO RELATED APPLICATION

This application claims the priority, under 35 U.S.C. § 119, of German Patent Application DE 10 2024 202 131.8, filed Mar. 7, 2024; the prior application is herewith incorporated by reference in its entirety.

### FIELD AND BACKGROUND OF THE INVENTION

The invention relates to a method for operating a hearing aid system. Furthermore, the invention relates to a hearing aid and a method for putting such a hearing aid system into operation.

People who suffer from hearing loss typically use a hearing aid device. In that case, ambient sound is usually acquired by an electromechanical sound transducer. The electrical signals created on the basis of the ambient sound are amplified by an amplifier circuit and introduced into the auditory canal of the person by a further electromechanical transducer in the form of a receiver. Moreover, the acquired sound signals are usually processed, for which a signal processor of the amplifier circuit is typically used. In that case, the amplification is matched to a possible hearing loss of the hearing aid device wearer, who is also referred to hereinafter as the user or wearer.

When the user himself or herself speaks, that is also acquired by the electromechanical sound transducer and amplified in accordance with the selected amplification and introduced into the auditory canal. As a result, the user perceives his or her own speech activity as being louder than is actually the case. That has the result that the user tends to speak more quietly. That in turn has the result that interlocutors can only follow the user with difficulty. In contrast, if the user still speaks with a volume pleasant for the interlocutor, that is unpleasant for the user due to the comparatively strong amplification.

### SUMMARY OF THE INVENTION

It is accordingly an object of the invention to provide a particularly suitable method for operating a hearing aid system, a hearing aid system and a method for putting a hearing aid system into operation, which overcome the hereinafore-mentioned disadvantages of the heretofore-known systems and methods of this general type and in which in particular a level of comfort is increased for a user and/or conducting a conversation is improved.

With the foregoing and other objects in view there is provided, in accordance with the invention, a method for operating a hearing aid system, in which an input signal is created on the basis of an ambient sound, the input signal is divided into a first signal component and a second signal component, the first signal component corresponds to speech of a user and the second signal component does not correspond to speech of the user, a first processed signal is created on the basis of the first signal component and a first amplification factor, a second processed signal is created on the basis of the second signal component and a second amplification factor, the two processed signals are combined to form an output signal, and the first amplification factor is selected depending on a ratio of the first signal component to the second signal component.

With the objects of the invention in view, there is also provided a hearing aid system, which has a hearing aid having a microphone for acquiring ambient sound and a signal processing unit, and which is operated according to a method of the invention.

With the objects of the invention in view, there is concomitantly provided a method for putting a hearing aid system according to the invention into operation, in which an input signal is created on the basis of ambient sound, the input signal is divided into a first signal component and a second signal component, wherein the first signal component corresponds to speech of a user and the second signal component does not correspond to speech of the user, and a dependency of the first amplification factor on the ratio of the first signal component to the second signal component is ascertained.

Advantageous refinements and embodiments are the subject matter of the respective dependent claims.

The method is used for operating a hearing aid system. The hearing aid system includes a hearing aid. For example, the hearing aid is a headphone or includes a headphone and the hearing aid is, for example, a headset. The hearing aid is particularly preferably a hearing aid device, however. The hearing aid device is used to assist a person suffering from a loss of hearing. In other words, the hearing aid device is a medical device through the use of which a partial hearing loss can be compensated for, for example. The hearing aid device is, for example, a “receiver-in-the-canal” hearing aid device (RIC; ex-receiver hearing aid device), an “in-the-ear” hearing aid device, an “in-the-canal” hearing aid device (ITC), or a “complete-in-canal” hearing aid device (CIC), hearing aid glasses, or a pocket hearing aid device. Alternatively, the hearing aid device is a “behind the ear” hearing aid device, which is worn behind a pinna.

The hearing aid is intended and configured to be worn on the human body. In other words, the hearing aid preferably includes a holding device, through the use of which it is possible to fasten it on the human body. If the hearing aid is a hearing aid device, the hearing aid is intended and configured to be disposed, for example, behind the ear or inside an auditory canal. In particular, the hearing aid is wireless and is intended and configured to be at least partially inserted into an auditory canal.

The hearing aid preferably includes a microphone, which is used to acquire sound. In particular, ambient sound, thus sound waves, or at least a part thereof is acquired by the microphone in operation. The microphone is expediently disposed at least partially inside a housing of the hearing aid and is therefore at least partially protected. The microphone is suitably an electromechanical sound transducer. The microphone has, for example, only a single microphone unit or multiple microphone units which interact with one another. Each of the microphone units expediently has a membrane which is set into vibrations by sound waves, wherein the vibrations are converted into an electrical signal by a corresponding pickup device, such as a magnet, which is moved in a coil. Alternatively thereto, the microphone units are configured to be capacitive, and the circumstance is utilized that an applied electrical voltage changes if the distance of the membrane to a static surface of the microphone unit changes. The electrical voltage is applied here in particular between the membrane and the static surface. The microphone units are preferably configured to be omnidirectional. In this or another way, it is at least possible to generate or at least provide an input signal by the microphone, which is based on the sound incident on the microphone, namely in particular the ambient sound.

The hearing aid expediently has a receiver for outputting an output signal. The output signal is in particular an electrical signal in this case, and, for example, is configured to be digital or suitably analog. The receiver is preferably an electromechanical sound transducer, for example a loudspeaker. Depending on the configuration of the hearing aid, in the intended state, the receiver is at least partially disposed inside an auditory canal of a user of the hearing aid, thus a person, who is also referred to as the wearer, user, or hearing aid wearer, or is at least acoustically connected thereto. The hearing aid is in particular primarily used for outputting the output signal by using the receiver, wherein a corresponding sound is created. In other words, the main function of the hearing aid is preferably outputting the output signal.

The hearing aid suitably includes a signal processing unit, through the use of which the possible microphone and the possible receiver are connected for signaling. The hearing aid expediently has a signal processor which, for example, forms the signal processing unit or is at least a component part thereof. The signal processor is, for example, a digital signal processor (DSP) or is implemented by using analog components. In particular the input signal created by the microphone is adapted by using the signal processor or at least the signal processing unit. The signal processing unit is at least suitable for this purpose, in particular intended and configured for this purpose. An A/D converter is expediently disposed between the microphone and the signal processing unit, for example the signal processor, if the signal processor is configured to be a digital signal processor. The hearing aid particularly preferably additionally includes an amplifier, or the amplifier is at least partially formed by the signal processing unit. For example, the amplifier is connected upstream or downstream from the signal processor with respect to signaling.

The hearing aid system is, for example, only formed by the hearing aid. However, the hearing aid system is particularly preferably formed from two such hearing aids, which are in particular structurally identical to one another. In this case, one of the hearing aids is assigned to a left ear and the other hearing aid to a right ear of the user. The hearing aid system is therefore configured to be binaural. In a further alternative, the hearing aid system includes, for example, a further device, which is expediently portable. The further device is, for example, a smart phone or another wearable. In particular, the individual component parts of the hearing aid system are connected to one another for signaling, for example in a wired or preferably wireless manner. Each of the devices of the hearing aid system expediently has a microphone, through the use of which the ambient sound can be acquired.

The method provides that the input signal is created on the basis of the ambient sound. In other words, in particular the ambient sound is acquired and the input signal is created on the basis thereof. The input signal is suitably an electrical signal, and the creation is expediently carried out by the microphone or microphones. The input signal corresponds in this case, for example, to the unprocessed ambient sound or is, for example, already processed. The input signal expediently has a specific directional characteristic, so that a specific part of the surroundings is acquired in an amplified manner, thus in particular sound from a specific spatial angle.

The input signal is divided into a first signal component and a second signal component. For example, the input signal includes still further components which are assigned to neither the first nor the second signal component. However, the input signal is particularly preferably divided completely into the first signal component and the second signal component, so that no further components are present. The first signal component corresponds here to speech of the user, whereas the second signal component does not correspond to speech of the user. Therefore, that part of the ambient sound which is induced due to speech of the user is assigned to the first signal component. In contrast, the other component parts are assigned to the second signal component. In particular, no component corresponding to sound which has arisen due to speech of the user is present in the second signal component. For example, a spatial analysis of where the ambient sound has arisen is performed for the division. Alternatively thereto, the division is carried out, for example, by a frequency analysis or in another manner. It is possible in this case that at least one of the signal components is at least temporarily not present. If the user is silent, in particular the first signal component is not present.

A first processed signal is created on the basis of the first signal component and a first amplification factor. In this case, for example, the first signal component is amplified by the first amplification factor, so that the first processed signal is created. The first amplification factor is, for example, a constant value. Alternatively thereto, the first amplification factor is, for example, not constant and in particular is dependent on a frequency of the respective individual component parts of the first signal component. In particular, the first amplification factor relates to an amplification, a compression, and/or a directionality. Alternatively or in combination therewith, the first amplification factor relates to noise suppression. At least the first signal component is processed by the first amplification factor, so that the first processed signal is created. In other words, the first amplification factor suitably corresponds to a parameter set through the use of which the first signal component is processed, so that the first processed signal is created. Preferably, only the processing by using the first amplification factor takes place in this case or, for example, still further processing steps take place in order to create the first processed signal.

Furthermore, a second processed signal is created on the basis of the second signal component and a second amplification factor. The second amplification factor is, for example, only a value which is constant. Alternatively thereto, it is dependent on a frequency of the individual component parts of the second signal component. Alternatively, a compression, a directionality, and/or a setting of a noise suppression is described by the second amplification factor. At least the second signal component is processed by the second amplification factor such that the second processed signal is created. For example, the second processed signal is only created on the basis of the processing by the second amplification factor, or still further processing steps take place for this purpose.

In a further work step, the two processed signals are combined to form the output signal. In particular, the two processed signals are added for this purpose, or combined in another manner, for example added in a weighted manner. The first signal component, the second signal component, the input signal, and the output signal are in particular electrical signals. The corresponding processing is expediently carried out by using the possible signal processing unit, suitably the digital signal processor. The output signal is expediently output, for example by using the possible receiver, so that in particular output sound is created which is suitably introduced into the auditory canal of the user.

The first and second amplification factor are, for example, always positive, negative, or can be both negative or positive, for example, expediently depending on specific requirements. The second amplification factor is preferably specified depending on a possible hearing loss of the user. Alternatively or in combination therewith, the second amplification factor is specified by the user, or in particular adapted thereto. Preferably, the second amplification factor is selected depending on the ambient sound and/or a classification of the surroundings. The first amplification factor, in contrast, is selected depending on a ratio of the first signal component to the second signal component. In particular, in this case the first amplification factor is dependent on the ratio of the level of the first signal component to the level of the second signal component.

Due to the method, the user therefore perceives the sound, which originates from his or her own speech, in a modified manner. In this case, if the user is located in comparatively calm surroundings, the ratio of the first signal component to the second signal component is different than if the user is located in comparatively loud surroundings. As a result, a different first amplification factor is then also selected. It is therefore possible to utilize the Lombard defect, through the use of which it is described that people in comparatively loud surroundings also (inadvertently) speak more loudly.

The first amplification factor is expediently reduced if the ratio of the first signal component to the second signal component is comparatively small and/or is below a specific limiting value, thus if the user speaks comparatively quietly in comparison to the surroundings. The user therefore perceives himself or herself as comparatively quiet, because of which he thereafter (in particular inadvertently) speaks more loudly. As a result, the user can also be reliably perceived by interlocutors even in comparatively loud surroundings. In summary, in the case of the comparatively small ratio, the first amplification factor is reduced so that the user's own speech is perceptible comparatively weakly for the user. As a result, the user will speak more loudly so that it is easier for interlocutors to understand the user.

In contrast, if the ratio of the first signal component to the second signal component is comparatively large, in particular is greater than a specific limiting value, the first amplification factor is preferably increased, so that the user's own speech is perceptible comparatively loud to the user. As a result, the user will speak more quietly so that the conversation runs more pleasantly for the interlocutor. Due to the quieter speech, in spite of the increased first amplification factor, the first signal component is then not excessively present in the output signal, so that a level of comfort for the user is not reduced. In summary, conducting a conversation with interlocutors is therefore improved, wherein no overexertion takes place for the user, so that a level of comfort is increased for him.

For example, it is stored in the hearing aid system, for example in the signal processing unit, by a producer of the hearing aid system how the first amplification factor is selected depending on the ratio, thus in particular its dependence. Alternatively or in combination therewith, the dependency is adapted by a person skilled in the art, for example. In a further alternative, the dependency is ascertained by a method for putting the hearing aid system into operation. This takes place in particular when the hearing aid system is used by the user, thus expediently after the hearing aid system is issued to the user.

For example, the input signal is only divided into the first and the second signal component. However, the second signal component is particularly preferably divided into a third signal component and a fourth signal component. This division takes place, for example, after a prior processing of the second signal component or expediently the division takes place in a work step with the division of the input signal into the first signal component.

The third signal component corresponds to a desired sound source, thus in particular sound which is evoked by an interlocutor or the like. The third signal component expediently corresponds to (ambient) sound from a specific spatial area, into which, for example, a directional lobe of the microphone is directed. In contrast, the fourth signal component corresponds to an interference noise source. A third processed signal is created on the basis of the third signal component and a third amplification factor and a fourth processed signal is created on the basis of the fourth signal component and a fourth amplification factor. The third and/or fourth amplification factor are component parts of the second amplification factor and are configured, for example, in accordance with the first amplification factor. For example, the third and/or fourth amplification factor are each a value which is constant or dependent on specific frequencies of the respective signal component, and/or a specific parameter set, through the use of which a compression or the like is set.

The third processed signal and the fourth processed signal are combined to form the second processed signal. The combination of the third and fourth processed signals preferably takes place in the same work step in which the combination with the first processed signal also takes place, so that the second processed signal is in particular only implicitly created. It is also possible here that one of the individual signal components is at least temporarily not present, for example the fourth signal component, if no interference noise source exists. Due to the division into the third and fourth signal component, it is possible to present noises, in particular sound, which does not interest the user to the user with a lower amplification so that the user is not distracted due to the interference noise source. A level of comfort is therefore further increased.

For example, the first amplification factor is selected depending on the ratio of the first signal component to a combination of the third and fourth signal components. However, the first amplification factor is particularly preferably only or at least also selected depending on a ratio of the first signal component to the fourth signal component. The user will therefore adapt his or her speech volume depending on the background noise, in particular the interference noise source. As a result, in comparatively loud surroundings, the user will speak more loudly due to the first amplification factor, which is then reduced.

For example, the first amplification factor is only selected in this case depending on the ratio of the first signal component to the fourth signal component. However, the first amplification factor is particularly preferably only or preferably additionally also selected depending on the ratio of the third signal component to the fourth signal component, thus in particular the level of the individual signal components in relation to one another. If the desired sound source corresponds with an interlocutor, the Lombard effect also acts for the latter. If the interlocutor only understands the user comparatively poorly, the interlocutor will speak more loudly so that the ratio of the third signal component to the fourth signal component is increased. In this case, at least if the ratio is above a specific limiting value, the first amplification factor will be reduced, in particular in comparison to the selection which results on the basis of the ratio of the first signal component to the fourth signal component. The user therefore speaks more loudly thereafter, so that the interlocutor understands the user better.

It is therefore also monitored on the basis of the selection of the first amplification factor depending on the ratio of the third signal component to the fourth signal component whether, for example, the first amplification factor is initially selected to be sufficient so that the interlocutor understands the user. In this case, the ratio of the third signal component to the fourth signal component is reduced and in particular corresponds to a specific expected value. In contrast, if the ratio is also still above a specific limiting value, the user is comparatively poorly comprehensible for the interlocutor. In this case, the first amplification factor will be reduced in particular, so that the user speaks more loudly and therefore comprehension is improved for the interlocutor.

For example, the first amplification factor is independent of the interference noise source. However, the interference noise source is particularly preferably categorized, for which purpose in particular the fourth signal component is analyzed. In other words, the interference noise source is assigned to one of multiple specific categories. For example, it is checked in this case whether the interference noise source is present due to operation of a machine or whether the interference noise source corresponds with a conversation of multiple other persons which the user does not wish to follow. Alternatively or in combination, it is checked whether the interference noise source corresponds to a driving noise due to the use of a vehicle. The first amplification factor is expediently selected in this case depending on the categorization. In this way, it is in particular taken into consideration that due to the changing volume of the speech of the user, possible other persons are not disturbed, and/or that the volume is not unpleasant for the interlocutor who is located in the same vehicle. It is always ensured in this case that due to the (inadvertently) changed volume of the user, comprehensibility on the part of the interlocutor is improved.

For example, the amplification factor is only selected once, in particular if specific surroundings are present. In other words, it is checked whether the surroundings change, and after a change the first amplification factor is selected accordingly. In contrast, if the surroundings do not change, the first amplification factor will also not be adapted further. However, the first amplification factor is particularly preferably continuously adapted. This takes place, for example, continuously over time or in specific discrete time intervals, for example every second, every 5 seconds, or every 10 seconds. It is therefore checked in particular whether the possible change/adaptation of the first amplification factor results in a changed ratio of the first signal component to the second signal component. If this corresponds to a specific expected value, the first amplification factor is expediently used further and not changed. In contrast, if the ratio differs from the expected value by more than a specific value, a (further) adaptation of the first amplification factor takes place so that the user also changes his or her speech volume.

The hearing aid system includes a hearing aid. The hearing aid is, for example, a headset or particularly preferably a hearing aid device. For example, the hearing aid device is a “receiver-in-the-canal” hearing aid device (RIC; ex-receiver hearing aid device), an “in-the-ear” hearing aid device, an “in-the-canal” hearing aid device (ITC), or a “complete-in-canal” hearing aid device (CIC), hearing aid glasses, or a pocket hearing aid device. Alternatively, the hearing aid device is a “behind the ear” hearing aid device, which is worn behind a pinna. For example, the hearing aid system is formed by the hearing aid or has at least one other device, such as another hearing aid, which is in particular structurally identical. Alternatively thereto, the other device is a further device which is portable in particular, such as a smart phone.

The hearing aid system has a microphone. This is configured to be omnidirectional, for example, or it is suitably possible to change a directional characteristic of the microphone. The microphone preferably has two or more microphone units for this purpose. The microphone is capable in this case of acquiring ambient sound, in particular intended and configured for this purpose. An input signal is expediently created by the microphone when the ambient sound is acquired. The hearing aid system, in particular the hearing aid, furthermore has a signal processing unit which is preferably connected to the microphone for signaling. In particular, the input signal is fed to the signal processing unit for this purpose during operation.

The hearing aid system is operated according to a method in which the input signal is created on the basis of the ambient sound. The input signal is divided into a first signal component and a second signal component, wherein the first signal component corresponds to speech of a user and the second signal component does not correspond to speech of the user. A first processed signal is created on the basis of the first signal component and a first amplification factor and a second processed signal is created on the basis of the second signal component and a second amplification factor. The two processed signals are combined to form an output signal. The first amplification factor is selected depending on a ratio of the first signal component to the second signal component. The signal processing unit is expediently capable, in particular intended and configured, to at least partially carry out the method.

The method for putting the hearing aid system into operation is carried out before the method for operating the hearing aid system is carried out. The dependence of the first amplification factor is ascertained by the method for putting the hearing aid system into operation. For example, the method for putting the hearing aid system into operation is repeated multiple times, in particular at periodic intervals. Alternatively thereto, the method is only carried out once or after initialization by a user.

In the method for putting into operation, the input signal is created on the basis of the ambient sound. The microphone is expediently also used for this purpose. Furthermore, the input signal is divided into the first signal component and the second signal component, wherein the first signal component corresponds to the speech of the user and the second signal component does not correspond to speech of the user. The creation of the input signal and/or the division into the two signal components expediently takes place in the same manner as during the following operation of the hearing aid corresponding to the (other) method.

After the division into the signal components, the ratio of the first signal component to the second signal component is ascertained. For this purpose, the respective input signal is expediently created in various different surroundings on the basis of the respective ambient sound, this input signal is divided into the signal components, and the ratio is ascertained. The first amplification factor is expediently ascertained by linear regression, so that a desired ratio is formed. In particular, the ratio is formed for each surroundings, for which purpose in particular the respective level is used. After this has taken place multiple times, the linear regression is carried out. For this purpose, a histogram is expediently initially created and the median of the slope and the offset of the assigned straight lines is ascertained. The slope then corresponds to the dependence of the first amplification factor on the ratio. The slope of the straight lines is preferably restricted here to a value between 0.3 dB and 0.7 dB.

The first amplification factor is suitably constant from a specific ratio, so that an excess change of the first signal component is suppressed. The first amplification factor or at least the change of the first amplification factor suitably corresponds to the minimum of 0 or an arbitrary value and the quotient of a difference and an auxiliary value. In order to form the difference, in particular the expected value is subtracted here from the ratio of the two signal components. The auxiliary value is preferably adapted here to the user and is preferably between 0.3 dB and 0.7 dB. The auxiliary value is preferably ascertained in this case by linear regression.

The first amplification factor is therefore selected correspondingly for different users on the basis of the method, since the Lombard effect differs for different people. As a result, a corresponding adaptation by the producer and/or a person skilled in the art, such as an audiologist, is not necessary, wherein the method is nonetheless comparatively precisely tuned to the user.

The refinements and advantages explained in conjunction with the two methods are also to be transferred accordingly to the hearing aid system and among one another and vice versa.

Other features which are considered as characteristic for the invention are set forth in the appended claims.

Although the invention is illustrated and described herein as embodied in a method for operating a hearing aid system, a hearing aid system and a method for putting a hearing aid system into operation, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a simplified, schematic, block diagram, of a hearing aid system;

FIG. 2 is a flow chart of a method for operating the hearing aid system;

FIG. 3 is a graph showing a course of a first amplification factor; and

FIG. 4 is a flow chart of a method for putting the hearing aid system into operation.

### DETAILED DESCRIPTION OF THE INVENTION

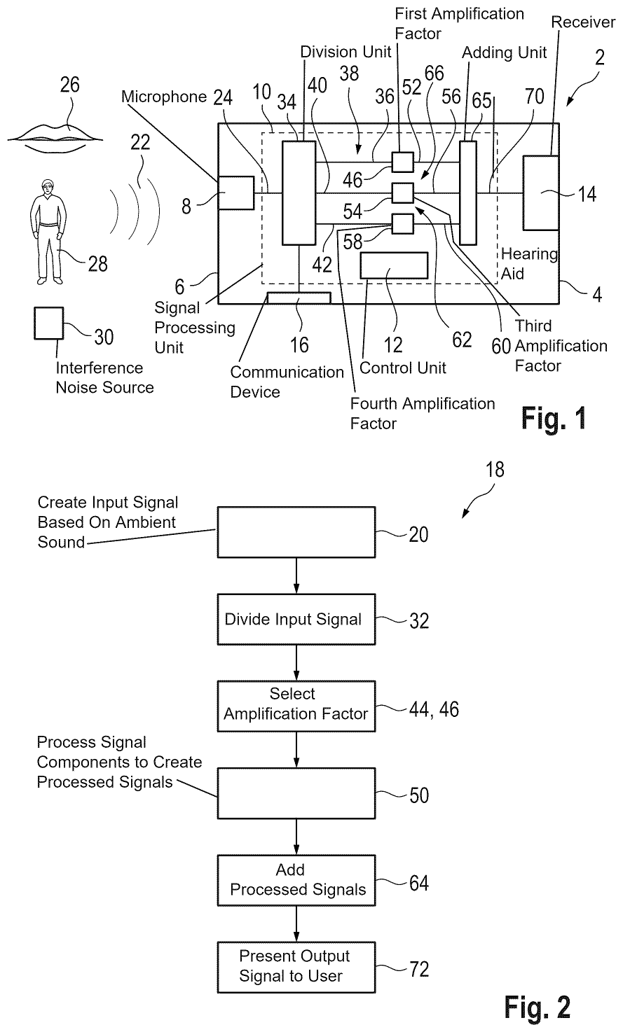

Referring now in detail to the figures of the drawings, in which parts corresponding with one another are provided with the same reference signs, and first, particularly, to FIG. 1 thereof, there is seen a block diagram of a hearing aid system 2, which includes a hearing aid 4 and is illustrated in schematically simplified form. The hearing aid 4 has a housing 6, within which a microphone 8 is disposed. The microphone 8 has multiple microphone units (not shown in more detail), which are each configured to be electromechanical sound transducers or capacitive sound transducers. A signal processing unit 10, which has a control unit 12, is connected downstream from the microphone 8 for signaling. A receiver 14, through the use of which it is possible to output sound into an auditory canal of the user (not shown in more detail) upon intended use by a user, is connected downstream from the signal processing unit 10 for signaling. Moreover, the hearing aid 4 has a communication device 16, which is also connected to the signal processing unit 10 for signaling.

The hearing aid system 2 has two such hearing aids 4, which are connected to one another for signaling during use by their respective communication device 16. A Bluetooth standard is used for the signaling connection in this respect. One of the hearing aids 4 is assigned to a left ear and the other to the right ear of the user, so that the hearing aid system 2 is configured to be binaural.

FIG. 2 shows a method 18 for operating the hearing aid system 2, which is at least partially carried out by the signal processing unit 10 of each hearing aid 4. In a first work step 20, an input signal 24 is created on the basis of ambient sound 22. For this purpose, the ambient sound 22 incident from outside the housing 6 on the respective microphone 8 is acquired by each of the microphones 8 and converted into the electrical input signal 24, which is conducted to the signal processing unit 10. The ambient sound 22 is composed of three components, wherein one of the components represents the speech 26 of the user himself or herself. A further of the components of the ambient sound 22 is present due to an interlocutor and is therefore present due to a desired sound source 28. The third component is evoked due to an interference noise source 30 and is not of interest to the user.

In a subsequent second work step 32, the input signal 24 is divided into a first signal component 36 and a second signal component 38 by a division unit 34 of the signal processing unit 10. The second signal component 38 is composed in this case of a third signal component 40 and a fourth signal component 42, so that the input signal 24 is divided by the division unit 34 directly into the first signal component 36 as well as the third signal component 40 and the fourth signal component 42.

The first signal component 36 corresponds in this case to the speech 26 of the user, and the second signal component 38 does not correspond to the speech of the user. In other words, the first signal component 36 only contains the speech 26 of the ambient sound 22. In contrast, the second component 38 has the remaining part of the ambient sound 22. The third signal component 40 corresponds in this case to the desired sound source 28, whereas the fourth signal component 42 corresponds to the interference noise source 30. In other words, the third signal component 40 therefore designates the part of the ambient sound 22 which is evoked by the desired sound source 28, whereas the fourth signal component 42 corresponds to the portion of the ambient sound 22 which is only present due to the interference noise source 30. For the division, it is checked by using a spatial analysis where the individual components of the ambient sound 22 originate. For this purpose, the directional characteristic of the microphones 8 of the two hearing aids 4 is set/checked against one another, for which purpose the communication devices 16 of the two hearing aids 4 are used.

A categorization of the interference noise sources 30 also takes place, for which purpose the fourth signal component 42 is checked. It is checked in this case whether the interference noise source 30 corresponds to a conversation of other people, or whether the interference noises emitted by the interference noise source 30 are travel wind noises of a vehicle or are evoked due to an operation of a machine.

In a subsequent third work step 44, a first amplification factor 46 is selected. This is dependent on a ratio 48 of the first signal component 36 to the fourth signal component 42, namely of the level of the first signal component 36 to the level of the fourth signal component 42. The first amplification factor 46 is therefore dependent on the ratio of the first signal component 36 to the second signal component 38, namely to the fourth signal component 42 of the second signal component 38.

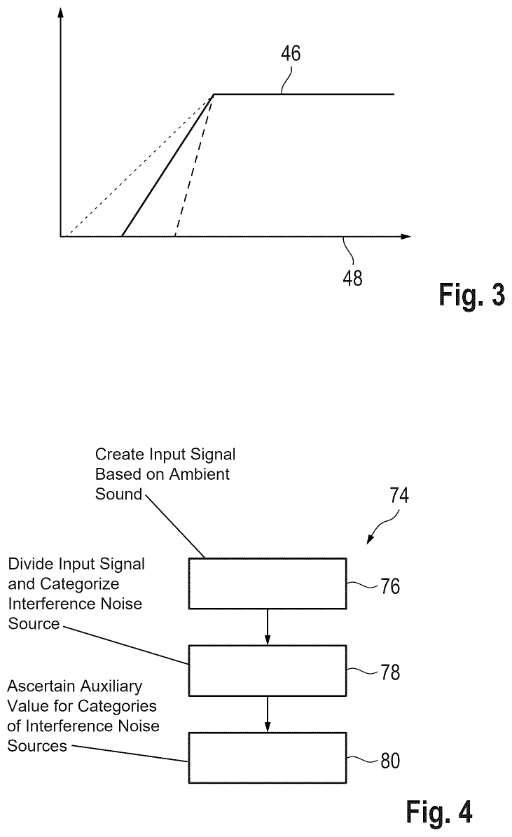

FIG. 3 shows the dependence of the first amplification factor 46 on the ratio 48, wherein the level of the amplification is indicated on the ordinate. The first amplification factor 46 is ascertained by using a formula, namely the minimum of a specific/predetermined value, such as 0, and a quotient. The quotient is formed in this case from a difference and an auxiliary value, which is between 0.3 dB and 0.6 dB and is adapted to the user. In order to form the difference, an expected value is subtracted from the current ratio 48. The first amplification factor 46 therefore has an at least partial/sectional linear dependence on the ratio 48. Moreover, the categorization of the interference noise source 30 is taken into consideration in the selection of the first amplification factor 46. Depending on the category, a different auxiliary value is used, so that the slope is different, as is also shown in the graph in FIG. 3. In summary, the first amplification factor 46 is also selected depending on the categorization of the interference noise source 30.

Moreover, the first implication factor 46 is also selected depending on a ratio of the third signal component 40 to the fourth signal component 42, wherein a linear dependence is likewise present. A correspondingly adapted formula is used for this purpose.

After the first amplification factor 46 has been determined, a fourth work step 50 is carried out. In this work step, the first signal component 36 is processed by using the first amplification factor 46, so that a first processed signal 52 is created. For this purpose, in particular the first signal component 36 is multiplied by the first amplification factor 46. Moreover, the third signal component 40 is processed by using a third amplification factor 54, so that a third processed signal 56 is created. The third amplification factor 54 is adapted in this case to a hearing loss of the user. The fourth signal component 42 is processed by using a fourth amplification factor 58, so that a fourth processed signal 60 is created. The fourth amplification factor 58 is comparatively small, so that the ratio of the third processed signal 56 to the fourth processed signal 60 is increased in comparison to the ratio of the third signal component 40 to the fourth signal component 42.

In summary, the third processed signal 56 is therefore created on the basis of the third signal component 40 and the third amplification factor 54 and the fourth processed signal 60 are created on the basis of the fourth signal component 42 and the fourth amplification factor 58. The third amplification factor 54 and the fourth amplification factor 58 together form a second amplification factor 62, through the use of which the second signal component 38 is processed.

In a following fifth work step 64, the third processed signal 56 and the fourth processed signal 60 are combined, namely added, to form a second processed signal 64 by using an adding unit 65 of the signal processing unit 10. In this case, the combination of the second processed signal 64 created in this way with the first processed signal 52 to form an output signal 70, which is output by the adding unit 65, also takes place simultaneously.

In a following sixth work step 72, the output signal 70 is output by the receiver 14 and therefore presented to the user. On the basis of the corresponding selection of the first amplification factor 46, the user's own speech is therefore presented to him or her in a changed volume, so that the user adapts his or her speech volume on the basis of the Lombard effect. In the hearing aid system 2, the Lombard effect is therefore considered/utilized, so that the user of the hearing aid system 2 adapts his or her speech volume (speaking volume) such that the ratio of the first signal component 36 to the fourth signal component 42, thus his or her speech volume to the volume of the interference noise source 30, reaches a specific expected value. A level of comprehensibility is thus increased for the interlocutor of the user. The method 18 is carried out continuously in this case, so that the first amplification factor 46 is continuously adapted.

FIG. 4 shows a method 74 for putting the hearing aid system 2 into operation. In a seventh work step 76, the input signal 24 is created on the basis of the ambient sound 22. The seventh work step 76 is substantially identical to the first work step 20 in this case. In a subsequent eighth work step 78, the input signal 24 is divided into the first signal component 36 and the second signal component 38. The further division into the third and fourth signal components 40, 42 also takes place here, and the eighth work step 78 is substantially identical to the second work step 32. A categorization of the possible interference noise source 30 also takes place here. The seventh and eighth work steps 76, 78 are carried out multiple times in different surroundings, in particular if different categories of interference noise sources 30 are present.

In a following ninth work step 80, on the basis of the respective ratios 48 of the first signal component 36 to the second signal component 38, the first amplification factor 46 for the different categories of the interference noise sources 30 is ascertained, namely the graphs shown in FIG. 3. The predetermined expected value is used in this case, and in particular the respective auxiliary value is ascertained for the different categories of the interference noise sources 30 in the ascertainment. For this purpose, a histogram of the ascertained ratios 48 is created in each case and the median is used as the respective auxiliary value.

The invention is not restricted to the above-described exemplary embodiment. Rather, other variants of the invention can also be derived therefrom by a person skilled in the art without departing from the subject matter of the invention. In particular, furthermore all individual features described in conjunction with the exemplary embodiment are also combinable with one another in other ways, without departing from the subject matter of the invention.

The following is a summary list of reference numerals and the corresponding structure used in the above description of the invention:
2 hearing aid system
4 hearing aid
6 housing
8 microphone
10 signal processing unit
12 control unit
14 receiver
16 communication device
18 method for operating a hearing aid system
20 first work step
22 ambient sound
24 input signal
26 speech
28 desired sound source
30 interference noise source
32 second work step
34 division unit
36 first signal component
38 second signal component
40 third signal component
42 fourth signal component
44 third work step
46 first amplification factor
48 ratio
50 fourth work step
52 first processed signal
54 third amplification factor
56 third processed signal
58 fourth amplification factor
60 fourth processed signal
62 second amplification factor
64 fifth work step
65 adding unit
66 second processed signal
70 output signal
72 sixth work step
74 method for putting a hearing aid system into operation
76 seventh work step
78 eighth work step
80 ninth work step

1. A method for operating a hearing aid system, the method comprising:
creating an input signal based on an ambient sound;
dividing the input signal into a first signal component and a second signal component, the first signal component corresponding to speech of a user and the second signal component not corresponding to speech of the user;
selecting a first amplification factor in dependence on a ratio of the first signal component to the second signal component;
creating a first processed signal based on the first signal component and the first amplification factor;
creating a second processed signal based on the second signal component and a second amplification factor; and
combining the first and second processed signals to form an output signal.

2. The method according to claim 1, which further comprises:
dividing the second signal component into a third signal component and a fourth signal component, the third signal component corresponding to a desired sound source and the fourth signal component corresponding to an interference noise source;
creating a third processed signal based on the third signal component and a third amplification factor;
creating a fourth processed signal based on the fourth signal component and a fourth amplification factor; and
combining the third processed signal and the fourth processed signal to form the second processed signal.

3. The method according to claim 2, which further comprises selecting the first amplification factor in dependence on a ratio of the first signal component to the fourth signal component.

4. The method according to claim 2, which further comprises selecting the first amplification factor in dependence on a ratio of the third signal component to the fourth signal component.

5. The method according to claim 2, which further comprises categorizing the interference noise source, and selecting the first amplification factor in dependence on the categorization.

6. The method according to claim 1, which further comprises continuously adapting the first amplification factor.

7. A hearing aid system, comprising:
a hearing aid having a microphone for acquiring ambient sound and a signal processing unit, the hearing aid being operated according to the method of claim 1.

8. A method for putting the hearing aid system according to claim 7 into operation, the method comprising:
creating the input signal based on ambient sound;
dividing the input signal into the first signal component and the second signal component, the first signal component corresponding to speech of the user and the second signal component not corresponding to speech of the user; and
ascertaining a dependency of the first amplification factor on the ratio of the first signal component to the second signal component.
